(19) United States
(12) Patent Application Publication
(10) Pub. No.: US 2002/0004347 A1
(43) Pub. Date: Jan. 10, 2002

(54) Fusible water-soluble embroidery liner

(75) Inventors: Manfred Jost, Hemsbach (DE); Peter Grynaeus, Birkenau (DE)

Correspondence Address: KENYON & KENYON, ONE BROADWAY, NEW YORK, NY, 10004, US

(73) Assignee: Firma Carl Freudenberg

(21) Appl. No.: 09/898,700

(22) Filed: Jul. 3, 2001

(30) Foreign Application Priority Data
Jul. 5, 2000 (DE) DE 10032769.9

(51) Int. Cl. B32B 5/02; B32B 5/00; B32B 27/12; B32B 7/00

(52) U.S. Cl. 442/149; 442/327; 428/219; 428/98; 428/220

(57) ABSTRACT

A water-soluble fusible embroidery liner, made of a water-stable nonwoven fabric having a weight per unit area of 20 to 120 g/m², which is coated by a water-soluble, thermoplastic polymer as the adhesive mass.

### BACKGROUND OF THE INVENTION

1. Field of the Invention

The present invention relates to a fusible water-soluble embroidery liner.

2. Description of Related Art

Embroidery liners are used essentially for stabilizing the base material to be embroidered in embroidery machines. The embroidery liner, as reinforcement, is clamped in the embroidery machines together with the base material and is embroidered together with the embroidery material. In the simplest case, the embroidery liner, after the embroidering, is removed by being pulled off from the base material. In this context, a remnant of the liner remains under the embroidery on the base material. These remaining liner remnants bring about a hardening of the embroidered points. In more sensitive embroideries, or rather in embroideries that are configured in a relief-like fashion, soluble liners are used which, after the embroidering process, can be removed by being dissolved.

From the document, German Patent A 43 43 230, a method for producing relief-like embroideries is known, in which a water-soluble gelatin film is arranged on the material, the embroidery is executed on the gelatin film and the material, and the embroidered material is dipped into water for removing the gelatin film and is then dried. A resin, for example, polyvinyl alcohol, is indicated as the gelatin film. Also, as the embroidery liner, acetate webs are known which can be removed from the embroidered material using the solvent acetone.

The known embroidery liners have the disadvantage that in the case of thin, very elastic embroidery base materials, simply placing together embroidery base and embroidery liner in a plane-parallel manner causes problems as a result of slipping or crimping. Furthermore, simply clamping embroidery base and embroidery liner in very wide large-scale embroidery machines presents a problem, one that is specifically caused, or aggravated, by the different expansion behaviors of the two materials. Although the embroidery base is highly elastic, the stabilizing embroidery liner is normally not supposed to be elastic. Additional problems arise if during the embroidery process a re-tightening is necessary. In this context, the embroidery base and the embroidery liner can shift with respect to each other, which, after the embroidery process is ended and the embroidery liner is washed out, can lead to a distortion in the embroidery image. Although from document WO 99/56519 a method for manufacturing embroidery products is known, along with support webs appropriate for this purpose, in which the embroidery base is stabilized through being coated by a water-soluble adhesive, nevertheless the slight coating thickness attainable only permits the manufacture of embroidered goods having a relief structure that is scarcely built up at all.

### SUMMARY OF THE INVENTION

It is an object of the invention to provide a fusible water-soluble embroidery liner, which can be fixed/fused in position on an embroidery base so that the above-mentioned problems are avoided.

This and other objects of the invention are achieved by a fusible water-soluble embroidery liner, which is composed of a water-soluble nonwoven fabric having a weight per unit area of 20 to 120 g/m², the fabric being coated by a water-soluble, thermoplastic polymer as an adhesive mass. A fusible embroidery liner of this type can be joined to the embroidery base in a generally known manner, for example, through heat lamination. Fixing the elastic embroidery material using the stabilizing fusible embroidery liner, which is fixed/fused over all of its surface, prevents the webs from slipping during the clamping process and provides for improved stability in the embroidering process. At the same time, the necessity of a retightening is reduced, or in the event of a retightening, the embroidery base and the embroidery liner can no longer slip with respect to each other. Since both the fusible embroidery liner as well as the adhesive mass that is applied thereon are water-soluble, no hardening substances remain in the embroidered products manufactured in this way.

### DETAILED DESCRIPTION OF THE INVENTION

The fusible embroidery liner is preferably such that the adhesive mass is composed of modified (co)polyamides, polyvinyl alcohols, and/or (co)polyesters. The aforementioned polymers, in this context, are modified in such a manner that they are water-soluble. In this way, it is assured that they can be removed from the embroidered product together with the fusible embroidery liner.

The fusible embroidery liner is also preferably such that the water-soluble nonwoven fabric is composed of a polyvinyl alcohol nonwoven fabric. Nonwoven fabrics of this type have proven themselves both with respect to the strength requirements as well as with respect to the subsequent removability by washing. A base material that can be used for the embroidery fixing-liner according to the present invention is described, for example, in the document, Japanese Patent 11/286859.

Particularly preferable is a fusible embroidery liner in which both the nonwoven fabric as well as the adhesive mass are water-soluble at temperatures of 10 to 40° C. The water-solubility of the nonwoven fabric and of the adhesive mass in the indicated temperature range makes possible a removal after the embroidery process that is favorable from the standpoint of energy. Furthermore, in this manner, embroidery yarns and/or embroidery bases can be used that are sensitive to heat or to warm water. Particularly preferable is a fusible embroidery liner in which the modification lies in an ethoxylation of the (co)polyamides and/or (co)polyesters or a saponification degree of the polyvinyl alcohol>95%. The corresponding modification of the polymers used as adhesive masses results in their being water-soluble.

According to the present invention, the method for manufacturing the fusible embroidery liner lies in applying the water-soluble, thermoplastic adhesive masses to the water-soluble nonwoven fabric through a spray coating process, a hot melt application, a lamination process using a spunbonded material that is made of the water-soluble, thermoplastic polymer, or through directly spinning the water-soluble, thermoplastic polymer onto the nonwoven fabric that is used as the base material. As result of the aforementioned methods, a fusible embroidery liner is obtained which can be fixed/fused on an embroidery base in a simple manner, for example, using a hot-calender process.

The adhesive mass is preferably bonded to the nonwoven fabric by sintering. In this manner, a solid bond between the fusible embroidery liner and the adhesive mass is achieved, which satisfies the technological requirements with respect to storage, transport, and use.

The present invention is described in greater detail on the basis of the following examples which should be regarded in an illustrative rather than a restrictive sense.

### EXAMPLE 1

Used as the base material for the fusible embroidery liner was a thermally bound nonwoven fabric made of cold-water-soluble polyvinyl alcohol (PVAL) staple fibers, having a weight per unit area of roughly 40 g/m². The PVAL fibers, in this context, were manufactured using the gel-spin method and they had a strength of 4 g/denier. Laminated onto this base material was a cold-water-soluble spunbonded material made of ethoxylated polyamide (NP2116 from the H.F. Fuller Co.) as the adhesive mass. The lamination process was carried out at 130° C. for over 15 s at 3 bar in a fusing press.

The finished fusible embroidery liner was joined to an elastic embroidery base at 130° C. The bond between the embroidery fixing-liner and the embroidery base has a peel strength of 5.2 N/5 cm.

### EXAMPLE 2

Applied onto a base material, in accordance with Example 1, are 14 g/m² of a water-soluble PVAL powder (Schaettifix 699 from the Schaetti & Co.) as the adhesive mass using a scattering spray-coating aggregate. In an infrared oven, the adhesive mass is sintered and, in the oven outlet, is tightly bonded to the base material using a pressure roller. The finished embroidery fixing-liner can be thermally laminated to an elastic embroidery base at 135° C.

What is claimed is:

1. A water-soluble fusible embroidery liner, comprising: a water-soluble nonwoven fabric having a weight per unit area of 20 to 120 g/m², coated by a water-soluble, thermoplastic polymer as an adhesive mass.

2. The fusible embroidery liner according to claim 1, wherein the water-soluble adhesive mass comprises a modified (co)polyamide, a modified polyvinyl alcohol or a modified (co) polyester.

3. The fusible embroidery liner according to claim 2, wherein 6 to 20 g/m² of a water-soluble adhesive mass is applied to the water-soluble nonwoven fabric.

4. The fusible embroidery liner according to claim 1, wherein the water-soluble nonwoven fabric is made of a polyvinyl alcohol nonwoven fabric.

5. The fusible embroidery liner according to claim 1, wherein both the nonwoven fabric and the adhesive mass are water-soluble at temperatures of 10 to 40° C.

6. The fusible embroidery liner according to claim 2, wherein both the nonwoven fabric and the adhesive mass are water-soluble at temperatures of 10 to 40° C.

7. The fusible embroidery liner according to claim 3, wherein both the nonwoven fabric and the adhesive mass are water-soluble at temperatures of 10 to 40° C.

8. The fusible embroidery liner according to claim 4, wherein both the nonwoven fabric and the adhesive mass are water-soluble at temperatures of 10 to 40° C.

9. The fusible embroidery liner according to claim 2, wherein the (co)polyamide and the (co)polyester are modified by ethoxylation and the polyvinyl alcohol is modified by saponification to a degree of >95%.

10. A method for manufacturing a fusible embroidery liner according to claim 1, comprising the step of applying a water-soluble, thermoplastic polymer adhesive mass to a water-soluble nonwoven fabric having a density of 20 to 120 g/m².

11. The method according to claim 10, wherein the adhesive mass is applied to the fabric by a scatter-coating process, a hot melt application, a lamination process using a spunbonded material that is made of the water-soluble, thermoplastic polymer, or by directly spinning the water-soluble, thermoplastic polymer onto the nonwoven fabric used as a base material.

12. The method according to claim 11, wherein 6 to 20 g/m² of water-soluble adhesive mass is applied to the water-soluble nonwoven fabric.

13. The method according to claim 11, wherein the adhesive mass is bonded to the nonwoven fabric by sintering.

14. The method according to claim 12, wherein the adhesive mass is bonded to the nonwoven fabric by sintering.
